(19) United States
(12) Patent Application Publication
(10) Pub. No.: US 2015/0070155 A1
(43) Pub. Date: Mar. 12, 2015

(54) PASSENGER INFORMATION SYSTEM AND METHOD

(71) Applicant: LAWO Informationssysteme GmbH, Rastatt (DE)

(72) Inventor: Hans-Joachim Reich, Karlsruhe (DE)

(21) Appl. No.: 14/546,232

(22) Filed: Nov. 18, 2014

Related U.S. Application Data
(63) Continuation of application No. PCT/EP2013/059103, filed on May 2, 2013.

(30) Foreign Application Priority Data
May 21, 2012 (DE) 102012010323.9

(51) Int. Cl. G09F 21/00; G09F 13/04; G09F 19/18

(52) U.S. Cl. CPC G09F 21/00; G09F 19/18; G09F 13/04
USPC 340/425.5

(57) ABSTRACT

Method for displaying passenger information on a passenger transport vehicle that has an interior and at least one window. The window has an inside, pointing to the interior, and an outside. At least one display section of the window is designed for the display of passenger information. The method includes the step of presenting the passenger information in the display section such that the passenger information can be read on the outside of the display section.

### CROSS REFERENCES TO RELATED APPLICATIONS

This is a continuation application of International patent application PCT/EP 2013/059103, filed May 2, 2013, which claims the priority of German patent application DE 10 2012 010 323.9, filed May 21, 2012.

### BACKGROUND OF THE INVENTION

The present invention relates to a method for displaying passenger information on a passenger transport vehicle that has an interior and at least one window which has an inside, pointing to the interior, and an outside.

In addition, the present invention relates to a passenger information system for displaying passenger information on a passenger transport vehicle, particularly for carrying out such a method, and to a passenger transport vehicle having such a passenger information system.

Passenger information systems for passenger transport vehicles such as buses, trains (particularly local rail vehicles), ships and the like are known generally. The passenger information systems are used to display passenger information such as a bus route, a railway line, a terminus or the like on the vehicle.

In general, such passenger information systems have display means, which may be realized electromechanically or electrically/electronically, for example.

Electromechanical displays of passenger information systems are frequently realized by means of bistable display elements (“Flip Dot”). In addition, segment displays are also known.

In addition, it is known practice for such journey destination displays to be realized by LCD or LED displays.

The display devices used in this instance are usually in box form and are mounted in the interior of the vehicle. On many passenger transport vehicles, the bodywork contains appropriate recesses for the display devices. However, it is also known practice for these display devices to be arranged behind windows of the passenger transport vehicle.

In this case, the display devices are frequently connected to a control device that can be operated by a driver or from a superordinate control center in a local transport interconnected system, for example.

The installation of the display devices in box form in the interior of the passenger transport vehicles leads to considerable restrictions in the design of the interior. In addition, these display devices are comparatively expensive.

### SUMMARY OF THE INVENTION

It is accordingly an object of the invention to specify an improved method for displaying passenger information, an improved passenger information system and an improved passenger transport vehicle.

The above object is achieved firstly by a method for displaying passenger information on a passenger transport vehicle that has an interior and at least one window that has an inside, pointing to the interior, and an outside, wherein at least one display section of the window is designed for the display of passenger information, having the step of presenting the passenger information in the display section such that the passenger information can be read on the outside of the display section.

In addition, the above object is achieved by a corresponding passenger information system that has display means for presenting the passenger information in the display section of the window such that the passenger information can be read on the outside of the display section, with the display means used for this purpose preferably being arranged in the interior of the passenger information system.

Finally, the above object is achieved by a passenger transport vehicle having such a passenger information system.

The basic concept of the present invention is that the passenger information does not require the use of display devices in box form if a display section is provided or reserved in or on the window of the passenger transport vehicle, within which display section the passenger information can be presented. This releases great degrees of freedom for the interior design of the passenger transport vehicle.

In addition, such passenger information systems can be realized inexpensively. Great degrees of freedom can also arise for the exterior design of the passenger transport vehicle, since the windows may be in extensive form.

In this case, the display section of the window is preferably an area of the window that is not used as a viewing area.

The object is therefore achieved completely.

According to a particularly preferred embodiment, the passenger information is projected onto the inside of the display section.

This can be accomplished by means of a projection device (“projector”), but can also be accomplished by means of a laser. In this case, the projection may be an image of the passenger information.

In this context, it is preferably possible to realize a very high resolution, which means that the passenger information can be presented in many variants and attractively.

According to a particularly preferred embodiment, the passenger information is projected onto the inside of the display section in mirror-inverted fashion in this case.

This allows the passenger information to be read in correctly mirrored fashion on the outside of the passenger transport vehicle.

According to a further embodiment, which is preferred overall, at least the display section of the window has an image-generating layer, particularly a transflective layer and/or a focusing screen.

In this case, the image-generating layer, which may be in the form of a film, for example, is used as a kind of “screen” for the projection. The image-generating layer is in this case designed such that the projected image is depicted thereon and can be read from the outside.

In this case, the image-generating layer may be arranged on the inside of the display section of the window, but may also be arranged on the outside of the display section of the window. In addition, it is possible for the imaging layer to be integrated into the window, for example in the form of an intermediate film.

According to one variant, the imaging layer has the function of a “focusing screen”.

Such a focusing screen is usually produced from a transparent plastic such as a film and usually has a smooth side and a frosted side. The image that is projected from an image source is depicted in the focusing screen in this case and can be read from the outside. Such a focusing screen may also be produced on the outside of the display section, on the inside thereof and/or as an intermediate film in the window.

The film is preferably transparent when no image is being cast thereon, which means that the display section appears preferably not at all or only a little when the image source is switched off.

The image source may be designed in the manner of a “projector”, that is to say with LED, LCD or DLP image elements, for example. In addition, the image source may also be designed in a manner customary for head-up displays.

According to an alternative embodiment, the display section of the window incorporates display means.

In this variant, the display section of the window may be produced in the manner of a liquid crystal display or the like, for example, but may also be realized as an LED display.

By way of example, liquid crystal displays can be realized essentially transparently, with almost invisible control elements being able to actuate individual pixels such that they dim out.

Accordingly, it is of particular advantage if the display section is illuminated from the inside in this embodiment.

This allows the image of the passenger information to be presented in the display section of the window by means of the display means, with the light from the light source being able to be focused onto the display section. In this case, the passenger information is presented by virtue of areas of the display section being dimmed specifically. It goes without saying that such display means must have an appropriate resolution that can correspond to that of a display of a computer, but may also be coarser, since it can be assumed that the display will in general be viewed from a relatively great distance.

In the case of the passenger transport vehicle according to the invention, it is of particular advantage if the display section is a section of a window through which passengers can look outside from the interior.

In this case, the window is designed such that it contains a viewing area and the display section. The display section may be separate from the viewing area in this case, but may also partly or completely overlap the viewing area.

This may be admissible at least in the area of side panes, for example. In the area of a front pane (windshield) of a passenger transport vehicle, it is preferred if the display section is situated outside the viewing area of this window.

In addition, it is advantageous for the passenger transport vehicle according to the invention if the display means have an image source that emits or projects an image containing passenger information, for example a projector or the like.

In addition, it is of particular advantage if at least one image source is arranged in a roof area of the passenger transport vehicle and/or if at least one image source is arranged in the area of a dashboard of the passenger transport vehicle.

In general, the image source may be oriented centrally and perpendicularly to a plane of the display section. In many cases, however, the image source is offset from this central axis and may be oriented obliquely with respect thereto, that is to say at an angle of less than 90°. In this case, it is preferred if the image of the passenger information is projected such that the distortions brought about by the offset are subtracted out in the first place.

In addition, it is preferred if the passenger information system has at least one brightness sensor in order to be able to adjust the brightness of the projection in automated fashion on the basis of the brightness of the surroundings.

It goes without saying that the features cited above and those that are yet to be explained below can be used not only in the respectively indicated combination but also in other combinations or on their own without departing from the scope of the present invention.

### BRIEF DESCRIPTION OF THE DRAWINGS

Exemplary embodiments of the invention are represented in the drawings and are explained in more detail in the following description. In the drawings:

FIG. 1 shows a side view of a passenger transport vehicle according to the invention;

FIG. 2 shows a front view of the passenger transport vehicle in FIG. 1;

FIG. 3 shows a view of a display section from an interior of a passenger transport vehicle;

FIG. 4 shows a partial view of a further embodiment of a passenger transport vehicle according to the invention;

FIG. 5 shows a schematic sectional view of an embodiment of a display section of a passenger information system according to the invention;

FIG. 6 shows an illustration of an alternative embodiment of a display section of a passenger information system, comparable to the illustration in FIG. 5; and

FIG. 7 shows an illustration of a further embodiment of a display section of a passenger information system according to the invention, comparable to the illustration in FIG. 5.

### DESCRIPTION OF PREFERRED EMBODIMENTS

FIG. 1 schematically shows a passenger transport vehicle that is denoted generally by 10. In the present case, the passenger transport vehicle 10 is a bus, as used in local transport, for example. However, the passenger transport vehicle may also be a rail vehicle, a ship, an aircraft or the like.

The vehicle 10 has an interior 12 that can accommodate at least one, preferably a plurality of, passenger(s). An exterior of the vehicle 10 is identified at 14.

The vehicle 10 has a front window 16 (windshield), a rear window 18 and a plurality of side windows, one of which is shown at 20.

The windows 16, 18, 20 each have an outside 26, which points to the exterior 14, and an inside 28, which points to the interior 12.

The explanations that follow relate to the front window 16. However, it goes without saying that the comments can refer in the same way to the rear window 18 and one or more side windows 20.

The front window 16 is divided into a viewing area 30 through which a driver has a view of the exterior, particularly the road. In addition, the front window 16 contains a display section 32, which in the present case is outside the viewing area 30, particularly above the viewing area 30.

The display section 32 has a transflective film 34 or a focusing screen or a frosted-glass pane. This imaging layer may either be provided exclusively in the display section 32 but may also be produced continuously over the entire front window 16.

The vehicle 10 contains a passenger information system 36. The passenger information system 36 contains a control device 38, which in the present case is accommodated in the area of a dashboard of the vehicle 10, for example. The control device 38 is capable of generating passenger information. To this end, the control device 38 may have an input device for a driver of the vehicle 10. However, the control device 38 may also be connected to a control center in a local transport system or the like.

In addition, the passenger information system 36 has at least one display means 39. In the present case, the passenger information system 36 has a display means 39 for the front windows 16, a display means 39′ for a side window 20 and a display means 39″ for the rear window 18.

The text below describes the display means 39 for the front window 16. However, the comments can be applied in equal measure to the display means 39′, 39″ for the side window 20 and the rear window 18.

The display means 39 is connected to the control device 38 and receives passenger information. The display means 39 has an image source 40 that may be in the form of a projector, for example. The image source 40 projects the received passenger information onto the inside 28 of the display section 32 (as shown at 42), which allows the passenger information to be read from the exterior 14.

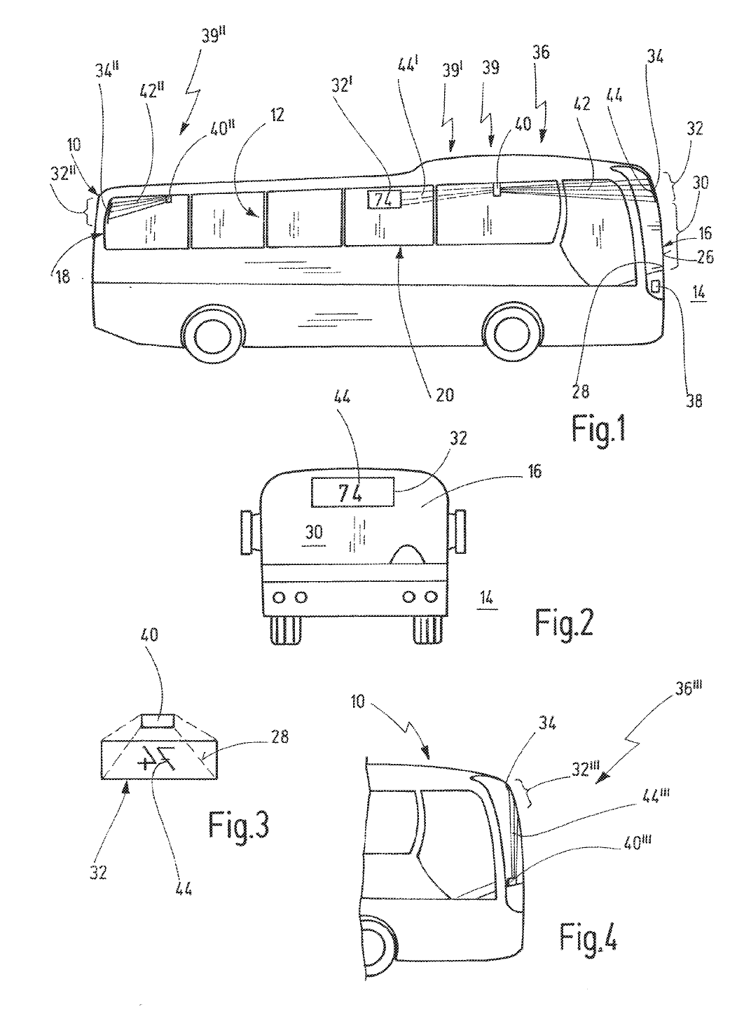

This is shown in FIG. 2 for the front window 16, with the display section 32 displaying a piece of passenger information 44 (“74”), for example a bus route or the like. The passenger information 44 may preferably comprise alphanumeric characters. In general, however, the passenger information may also contain image information, for example pictograms or the like.

FIG. 3 shows that the image source 40 projects the passenger information 44 onto the inside 28 of the display section 32 in mirror-inverted fashion such that the passenger information 44 can be read from the exterior 14 correctly from left to right.

In the present case, the image source 40 is mounted in a roof area of the vehicle 10. In this case, the image source 40 may be oriented onto the display section 32 perpendicularly but may also be oriented obliquely with respect thereto. The control device 38 and/or the image source 40 provide the passenger information such that essentially distortion-free display of the passenger information on the respective display sections 32 is possible.

FIG. 4 shows an alternative embodiment of a passenger information system 36′″, which embodiment involves the image source 40′″ being mounted in the area of a dashboard of the motor vehicle 10 and being projected essentially vertically upward, as shown at 44′″.

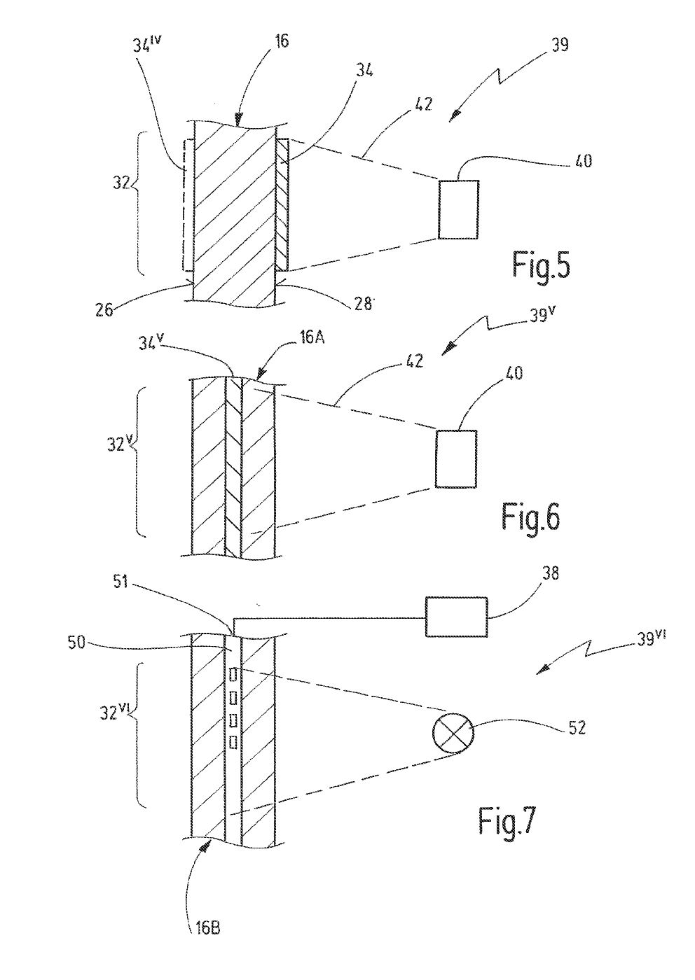

FIGS. 5 to 7 show alternative embodiments of display means 39. In this case, FIG. 5 corresponds to the embodiment in FIGS. 1 to 4, with an imaging layer 34 being positioned on the window 16 from inside in the area of a display section 32, for example by means of an adhesive bonding method.

Alternatively, such an imaging layer may also be positioned on an exterior 26 of the window 16 (as shown at 34^{IV}).

FIG. 6 shows an alternative embodiment in which the imaging layer 34^{V} is incorporated in a window 16A, for example as an intermediate layer between two single glass panes.

In this case, the imaging layer 34^{V} is preferably incorporated over the entire surface area of the window 16A, the display section 32^{V} being set up by focusing of the projection 42 from the image source 40.

FIG. 7 shows an alternative embodiment in which the display section 32^{VI} of a window 16B incorporates display means 50, which may be produced in the manner of a liquid crystal display, for example. In this case, the display device 50 preferably has a plurality of display elements 51, the size and density of which can correspond to those of a display of computers but can also have a coarser resolution.

For the display means 39^{VI} in FIG. 7, it is preferred if the inside 28 of the display section 32^{VI} is illuminated by means of a light source 52, the display elements 51 being either translucent or else dimmed in order to display passenger information in this manner.

It goes without saying that measures for glare-free presentation of the passenger information may be embodied in all variants.

In addition, it goes without saying that the display means in the various variants may be controlled in terms of brightness, on the basis of the brightness of the surroundings.

1. A method for displaying passenger information on a passenger transport vehicle that has an interior and at least one window which has an inside, pointing to the interior, and an outside, wherein at least one display section of the window is designed for the display of passenger information, having the step of:
presentation of the passenger information in the display section such that the passenger information can be read on the outside of the display section.

2. The method as claimed in claim 1, wherein the passenger information is projected onto the inside of the display section.

3. The method as claimed in claim 1, wherein the passenger information is projected onto the inside of the display section in mirror-inverted fashion.

4. The method as claimed in claim 1, wherein at least the display section of the window has an image-generating layer.

5. The method of claim 4, wherein the image-generating layer is a transflective layer.

6. The method of claim 4, where the image-generating layer is a focusing screen.

7. The method as claimed in claim 1, wherein the display section of the window incorporates display means.

8. The method as claimed in claim 4, wherein the display section is illuminated from the inside.

9. A passenger information system for displaying passenger information on a passenger transport vehicle that has an interior and at least one window which has an inside, pointing to the interior, and an outside, wherein at least one display section of the window is designed for the display of passenger information, having display means for presenting the passenger information in the display section of the window such that the passenger information can be read on the outside of the display section.

10. A passenger transport vehicle that has an interior and at least one window which has an inside, pointing to the interior, and an outside, wherein at least one display section of the window is designed for the display of passenger information, and that has a passenger information system for displaying information, the passenger information system having display means for presenting the passenger information in the display section of the window such that the passenger information can be read on the outside of the display section.

11. The passenger transport vehicle as claimed in claim 10, wherein the display section is a section of a window through which passengers can look outside from the interior.

12. The passenger transport vehicle as claimed in claim 10, wherein the display section has an image source that emits an image containing passenger information.

13. The passenger transport vehicle as claimed in claim 12, wherein at least one image source is arranged in the roof area of the passenger transport vehicle.

14. The passenger transport vehicle as claimed in claim 12, wherein at least one image source is arranged in the area of a dashboard of the passenger transport vehicle.
